(19) United States
(12) Patent Application Publication
(10) Pub. No.: US 2025/0175507 A1
(43) Pub. Date: May 29, 2025

(54) IMS NODES AND METHODS PERFORMED IN A COMMUNICATION NETWORK

(71) Applicant: Telefonaktiebolaget LM Ericsson (publ), Stockholm (SE)

(72) Inventors: Jörgen AXELL, Danderyd (SE); David CASTELLANOS ZAMORA, Madrid (ES); Emiliano MERINO VAZQUEZ, Madrid (ES)

(21) Appl. No.: 18/726,878

(22) PCT Filed: Jun. 23, 2022
(86) PCT No.: PCT/EP2022/067161

§ 371 Date: Jul. 5, 2024

(30) Foreign Application Priority Data
Jan. 11, 2022 (EP) 22382011.9

(51) Int. Cl. H04L 65/1073; H04L 61/3015; H04L 65/1016; H04L 65/1104

(52) U.S. Cl. CPC H04L 65/1073; H04L 61/3025; H04L 65/1016; H04L 65/1104

(57) ABSTRACT

Embodiments herein relate to, for example, a method performed by a first IMS node for handling SIP signalling in a communication network. The first IMS node transmits to a second IMS node, a message related to SIP signalling for a user equipment, UE, wherein the message includes an indication indicating a group of subscriber servers for the UE.

### TECHNICAL FIELD

Embodiments herein relate to a first Internet Protocol (IP) Multimedia Subsystem (IMS) node, a second IMS node, and methods performed therein regarding communication. Furthermore, a computer program product and a computer-readable storage medium are also provided herein. Especially, embodiments herein relate to handling session initiation protocol (SIP) signalling in a communication network.

### BACKGROUND

In a typical communication network, user equipments (UE), also known as communication devices, e.g., mobile stations, stations (STA) and/or wireless devices, communicate via an Access Network (AN) to one or more core networks (CN). In case the AN is a Radio access network (RAN), the RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers and service providers propose and agree upon standards for present and future generation networks, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and also for fifth generation (5G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit-and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF).

The Internet Protocol (IP) Multimedia Subsystem (IMS) is a well-known 3GPP standard allowing sessions to be setup between two or more parties for a broad variety of services such as voice or video call, interactive messaging sessions or third-party specific applications. A protocol chosen by 3GPP is the Session Initiation Protocol (SIP). The SIP provides a mechanism for registration of UEs and for setting up multimedia sessions. The SIP REGISTER method enables the registration of user agent's current location and the SIP INVITE method enables the setting up of a session. IMS is implemented by Public Land Mobile Network (PLMN) operators as an architectural framework for delivering IP multimedia services to their subscribers.

An IMS network comprises several network entities, some of which are discussed here.

Home Subscriber Server (HSS); an HSS is a subscriber database comprising subscriber profiles, performs authentication and authorization, and provides information on services provisioned for subscribers and information on the location and IP address of a subscriber.

Serving Call Session Control Function (S-CSCF); an S-CSCF is a SIP server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them on

Interrogating Call Session Control Function (I-CSCF); an I-CSCF is a SIP server and located at the edge of an administrative domain. Its IP address is published in the Domain Name System (DNS) of the domain, so that remote servers can find it and use it as a forwarding point for SIP packets to this domain. It queries the HSS to retrieve the address of the S-CSCF and assigns the S-CSCF to a user performing SIP registration and also forwards SIP requests or responses to the S-CSCF.

### SUMMARY

As a part of developing embodiments herein a problem has first been identified and will be discussed herein. In FIG. 1 it is disclosed that P-User-Database SIP header field, see RFC 4457, has been defined to provide, to the S-CSCF, an HSS Diameter Uniform Resource Identifier (URI) that has replied to I-CSCF after a user lookup in a subscriber location function (SLF), so that the S-CSCF does not need to perform a user lookup again in SLF.

In 5G and in Service Based Interface (SBI) procedures, Hypertext Transfer Protocol (HTTP) is used instead of Diameter, and also HSS group ID is used identifying a group of HSSs. The HSS group ID is not a Diameter URI. See FIG. 2.

An object of embodiments herein is to provide a mechanism enabling an efficient SIP signalling in a communication network.

According to an aspect the object is achieved by providing a method performed by a first IMS node for handling SIP signalling in a communication network. The first IMS node transmits to a second IMS node a message related to SIP signalling for a UE, wherein the message comprises an indication indicating a group of subscriber servers for the UE.

According to another aspect the object is achieved by providing a method performed by a second IMS node for handling SIP signalling in a communication network. The second IMS node receives from a first IMS node, a message related to SIP signalling for a UE, comprising an indication indicating a group of subscriber servers for the UE. The second IMS node retrieves subscriber data for the UE based on the received indication.

It is furthermore provided herein a computer program product comprising instructions, which, when executed on at least one processor, cause the at least one processor to carry out any of the methods above, as performed by the first and second IMS nodes, respectively. It is additionally provided herein a computer-readable storage medium, having stored thereon a computer program product comprising instructions which, when executed on at least one processor, cause the at least one processor to carry out the method according to any of the methods above, as performed by the first and second IMS node, respectively.

According to yet another aspect the object is achieved by providing a first IMS node for handling SIP signalling in a communication network. The first IMS node is configured to transmit to a second IMS node a message related to SIP signalling for a UE, wherein the message comprises an indication indicating a group of subscriber servers for the UE.

According to still another aspect the object is achieved by providing a second IMS node for handling SIP signalling in a communication network. The second IMS node is configured to receive from a first IMS node, a message related to SIP signalling for a UE, wherein the message comprises an indication indicating a group of subscriber servers for the UE. The second IMS node is configured to retrieve subscriber data for the UE based on the received indication.

Embodiments herein relate to methods and apparatuses for indicating the group of subscriber servers, such as an HSS group ID or NF set, to the second IMS node. For example, the first IMS node may create a fully qualified domain name (FQDN) in the diameter URI containing the HSS group ID in a format which identifies that the diameter URI is not a valid URI but an HSS group ID, in order to reuse the P-User-Database header field to convey this information. This way, an existing SIP header is used for HSS addressing. Alternatively, a new SIP header, e.g., 5gc-Group-Id, may be used. Another alternative is to use the route header where the S-CSCF name is included and a new (and standard) URI parameter is appended, e.g., sip:scscf-1.ericsson.com; hss-gid=hss-group-1. Hence, embodiments herein enabling an efficient SIP signalling in the communication network such as a 5GC.

### BRIEF DESCRIPTION OF DRAWINGS

Embodiments will now be described in more detail in relation to the enclosed drawings, in which:

FIG. 1 shows a schematic signalling scheme according to RFC 4457;

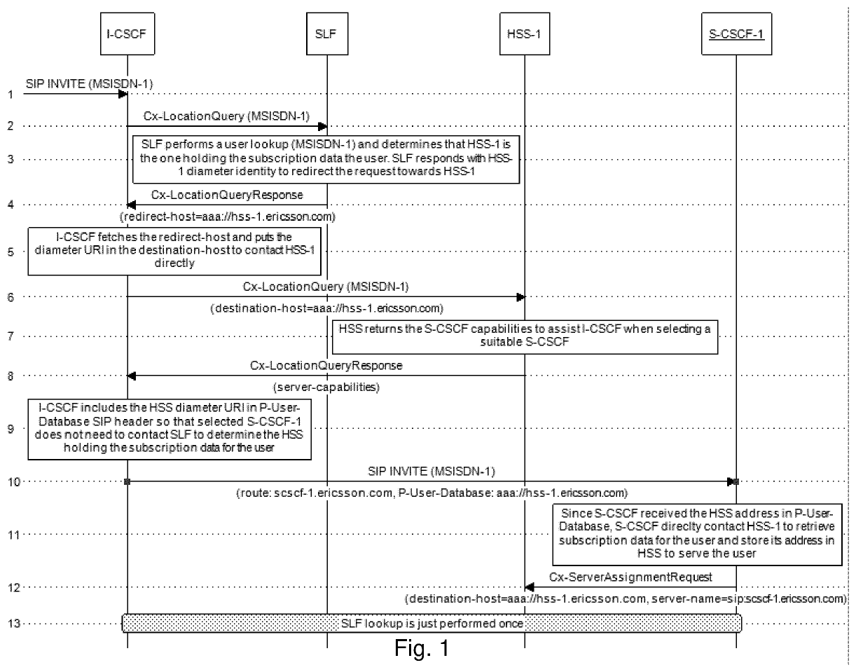

FIG. 2 shows a schematic signalling scheme according to prior art;

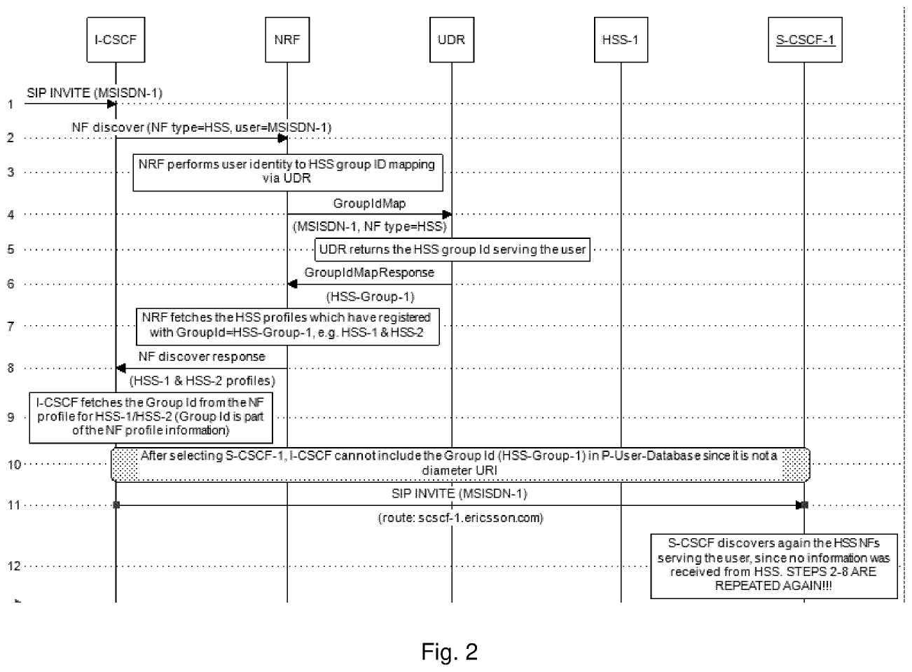

FIG. 3 shows a schematic overview depicting a communication network according to embodiments herein.

FIG. 4 shows a combined signalling scheme and flowchart according to embodiments herein.

FIG. 5 shows a combined signalling scheme and flowchart according to embodiments herein.

FIG. 6 shows a method performed by a first IMS node according to embodiments herein.

FIG. 7 shows a method performed by a second IMS node according to embodiments herein.

FIGS. 8a-8b show block diagrams depicting a first IMS node according to embodiments herein.

FIGS. 9a-9b show block diagrams depicting a second IMS node according to embodiments herein.

### DETAILED DESCRIPTION

Embodiments herein are described in the context of 5G/NR but the same concept can also be applied to other communication systems. Embodiments herein may be described within the context of 3GPP NR radio technology, e.g., using gNB as the radio network node. It is understood, that the problems and solutions described herein are equally applicable to wireless access networks and user equipments (UE) implementing other access technologies and standards. NR is used as an example technology where embodiments are suitable, and using NR in the description therefore is particularly useful for understanding the problem and solutions solving the problem. In particular, embodiments are applicable also to 3GPP LTE and NR integration, also denoted as non-standalone NR.

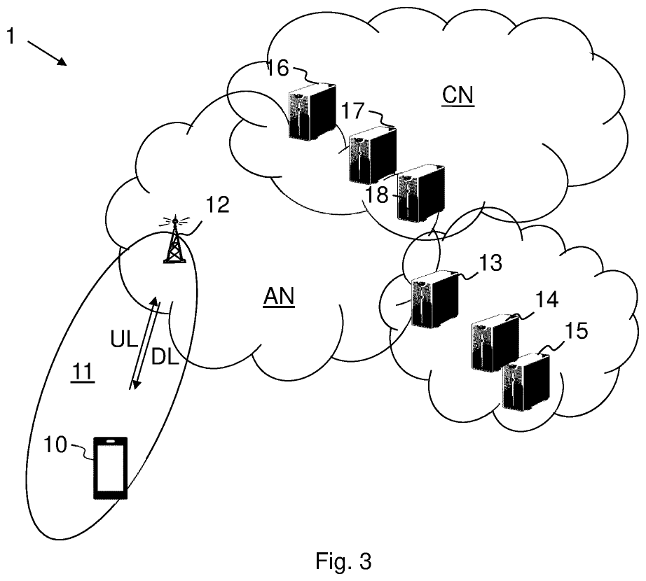

Embodiments herein relate to communication networks in general. FIG. 3 is a schematic overview depicting a communication network 1. The communication network 1 comprises one or more ANs and one or more CNs. The communication network 1 may use one or a number of different technologies. Embodiments herein relate to recent technology trends that are of particular interest in a New Radio (NR) context, however, embodiments are also applicable in further developments of existing wireless communications systems such as e.g. LTE or Wideband Code Division Multiple Access (WCDMA).

In the communication network 1, a user equipment (UE) 10, exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The functional components of communication network 1 comprises a radio network node 12 providing radio coverage over a geographical area, a first service area 11, or a first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the UE in form of DL transmissions to the UE and UL transmissions from the UE. It should be noted that a service area may be denoted as cell, beam, beam group or similar to define an area of radio coverage.

The communication network 1 further comprises an Internet Protocol (IP) Multimedia Subsystem (IMS) network, in which IMS network, a first IMS node 13, a second IMS node 14 and a subscriber server 15 operates. The IMS network is an architecture for delivering media content over an IP packet switched transport.

The first IMS node 13 may be used for forwarding incoming IMS signalling to/from the UE 10 via intermediate nodes, such as the second IMS node 14 and may be an I-CSCF.

The second IMS node 14 may be used for performing session control service for the UE 10 and may be an S-CSCF.

The subscriber server 15 may be used for handling subscriber data for the UE 10 and may be an HSS.

The communication network 1 may further comprise a number of core network nodes providing, e.g. in NR, network functions (NF) or actually instantiations of NFs also referred to as NF instances, such as a first network node 16 providing, for example, an instantiation of a network repository function (NRF), a second network node 17 providing an instantiation of an UDM, and a third network node 18 providing, for example, an instantiation of an AMF, or any other NF instances in the communication network 1. The different NF instances may have different tasks.

The respective node may be a standalone server, a cloud-implemented server, a distributed server or processing resources in a server farm or same node.

In IMS, SIP REGISTER requests generated by the UE 10 traverse a set of SIP proxy servers before reaching a SIP registrar. A REGISTER request sent by the UE 10 is routed to the outbound proxy of the UE 10, which is referred to as a Proxy-Call/Session Control Function (P-CSCF). The P-CSCF routes the REGISTER request to another proxy, which is referred to as the I-CSCF, i.e., the first IMS node 13 and is located in a home domain of the UE 10. The I-CSCF consults a user database of the domain, which is referred to as the HSS, i.e., the subscriber server 15, in order to choose the registrar that will process the REGISTER request. With the information received from the HSS, the I-CSCF routes the REGISTER request to the appropriate registrar, which is referred to as the S-CSCF, i.e., the second IMS node 14. In legacy, the S-CSCF will contact the same HSS that was previously contacted by the I-CSCF in order to fetch the user profile of the user that generated the REGISTER request. An IMS over Service Based Interface (SBI) architecture has recently been standardized by 3GPP. This replaces the legacy Cx and Sh interfaces in favor of SBI interfaces, such as HTTP-based and cloud-native based interfaces. This enables the use of indicating a group of subscriber servers handling a UE.

According to embodiments herein the first IMS node 13 transmits to the second IMS node 14 a message related to SIP signalling such as a SIP INVITE or a SIP REGISTER, wherein the message comprises an indication indicating a group of subscriber servers for the UE 10. The indication may comprise an HSS group ID or an NF set. Thus, the second IMS node 14 receives the message comprising the indication. The second IMS node 14 then retrieves subscriber data for the UE based on the received indication. Thus, the second IMS node may select a subscriber server from the group of subscriber servers indicated. The second IMS node may select the subscriber server based on a criterion such as location and proximity or similar. Thus, the second IMS node may select a different subscriber server than the first IMS node would select, for example, in case they are located at different locations.

The indication may be comprised in a fully qualified domain name (FQDN) in a diameter URI. Thus, the FQDN may comprise an HSS group ID or an NF set in the form of a token, a cookie or a format, which identifies that the diameter URI is not a valid URI but an HSS group ID, in order to reuse the P-User-Database header field to convey this information. This way, an existing SIP header is reused, but used for HSS addressing. It should be noted that the indication may alternatively or additionally comprise an NF set identifying the group of subscriber servers.

Alternatively, a new SIP header may be used comprising the indication, e.g., 5gc-Group-Id.

Another alternative is to use a route header where the S-CSCF name is included and a new URI parameter may be appended, e.g., sip:scscf-1.ericsson.com; hss-gid=hss-group-1. Thus, reusing a SIP header which is used for SIP routing, not for HSS addressing.

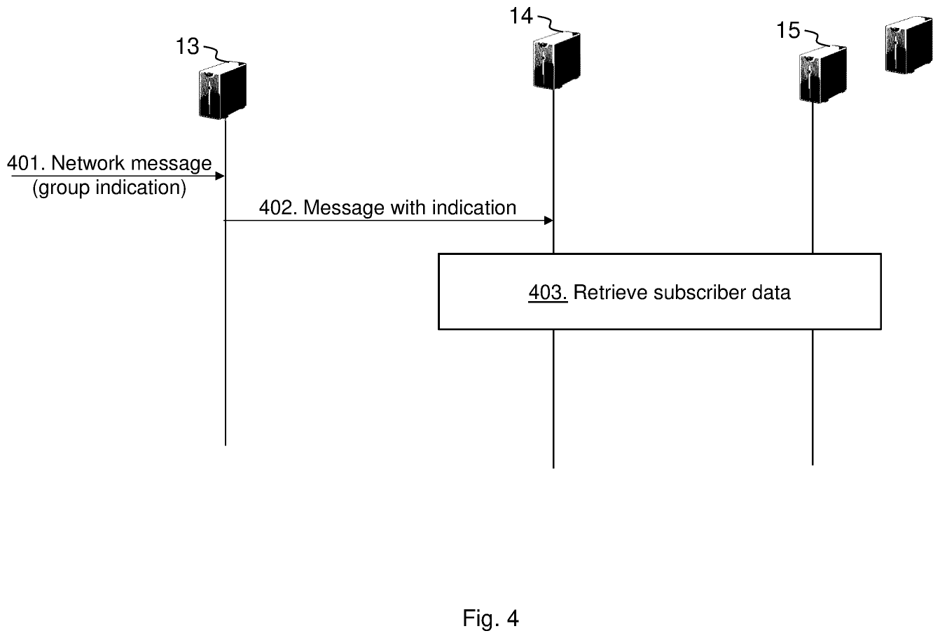

FIG. 4 is a combined signalling scheme and flowchart according to embodiments herein.

Action 401. The first IMS node 13 may receive a network message from a network node such as an NRF or similar, wherein the network message indicates a group of subscriber servers comprising subscriber data of the UE 10.

Action 402. The first IMS node 13 transmits the message related to SIP signalling, such as a SIP INVITE message. The message comprises the indication indicating the group of subscriber servers for the UE 10. The indication may be a diameter URI FQDN in the form of “5gc.hssgid.<HSSGID>.invalid” to convey the HSS group Id. The indication may look like this: aaa://5gc.hssgid.hss-group-1.invalid. The indication, such as a magic cookie, token or format may be “5gc.hssgid.” to indicate to S-CSCF, or any other NF, e.g., IMS-AS, that the diameter URI is carrying an HSS Group Id.

Action 403. The second IMS node 14 receives the message and retrieves subscriber data of the UE 10 from the subscriber server 15 based on the received indication. For example, the second IMS node 14 may detect the format of the Diameter URI and may fetch the group ID to use HSS NF profiles cached. The second IMS node 14 may contact the subscriber server 15 directly without an NF node interaction.

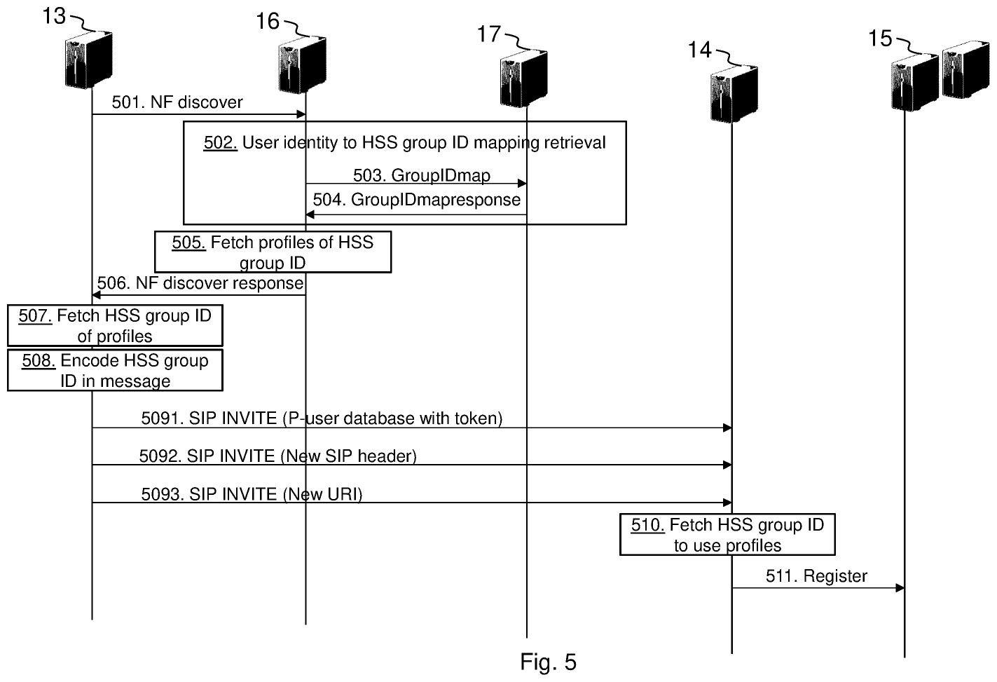

FIG. 5 is a combined signalling scheme and flowchart according to embodiments herein. The first IMS node 13 is exemplified as an I-CSCF, the second IMS node 14 as an S-CSCF, and the subscriber server 15 as an HSS.

Action 501. The first IMS node 13 may perform a NF discovery by transmitting to the first network node 16, a NF discover comprising NF type=HSS, user=MSISDN-1, thus indicating request for an HSS and for which UE indicated by, e.g., the Mobile Station International Subscriber Directory Number (MSISDN).

Action 502. The first network node 16 receives the NF discover and may perform a retrieval of a mapping between the UE (user identity) to a HSS group ID via the second network node 17 such as an UDR. This is service based architecture, using HTTP.

Action 503. The first network node 16 may, for example, transmit, to the second network node 17, a request for the mapping. For example, the first network node 16 may transmit a GroupIDmap request.

Action 504. The second network node 17 may return or obtain the HSS group ID serving the UE 10. Thus, the second network node 17 may further transmit a response back to the first network node 16. For example, the second network node 17 may transmit a groupIDMapresponse comprising a group indication.

Action 505. The first network node 16 may then fetch HSS profiles which have registered with the groupID indicated by the group indication. For example, the first network node 16 may fetch HSS profiles for HSS-1 and HSS-2.

Action 506. The first network node 16 may transmit the network message, wherein the network message indicates the group of subscriber servers comprising subscriber data of the UE 10. For example, the first network node 16 may transmit an NF discover response comprising profiles of the HSS of the group.

Action 507. The first IMS node 13 may thus, fetch group ID from the NF profiles for HSS-1 and/or HSS-2. Group ID is part of NF profile information.

Action 508. According to the embodiments herein, the first network node 13 may encode HSS group ID, such as HSS-group-1, in P-User-Database as a diameter URI, but the diameter URI may include a token, cookie, or format indicating the group ID.

Action 5091. The first IMS node 13 then transmits to the second IMS node 14, the message such as the SIP INVITE comprising the MSISDN. The message comprises the indication indicating the group of subscriber servers for the UE 10. For example, the indication may indicate a group identity by using an existing SIP header field such as ‘Route: scscf-1.ericsson.com, P-User-Database: aaa://5gc.hssgid.hss-group-1.invalid’. Thus, the mapping of user identity to HSS group ID is only performed once with a token or cookie and diameter URI to convey the group ID.

Action 5092. Alternatively, the first IMS node 13 then transmits to the second IMS node 14, the message with the indication that may be comprised in a new SIP header field such as ‘Route: scscf-1.ericsson.com, P-5gc-Group-Id: hss-group-1’.

Action 5093. Alternatively, the first IMS node 13 then transmits to the second IMS node 14, the message with the indication that may be comprised in a SIP URI parameter such as ‘Route: <scscf-1.ericsson.com; 5gc-group-id=hss-group-1>’.

Action 510. The second IMS node 14 may detect the format of the diameter URI and may fetch the HSS group ID to use the HSS NF profiles cached. For example, due to previous HSS NF discovery request for the same group ID. The second IMS node 14 may thus contact the proper subscriber server 15, based on the group ID, directly without an NF node interaction. This may be performed based on a criterion at the second IMS node 14 for the second IMS node 14 to select the HSS to contact.

Action 511. The second IMS node 14 may then transmit a register message to the subscriber server 15. For example, the second IMS node may transmit to the subscriber server 15, an Nhss_UECM_Register.

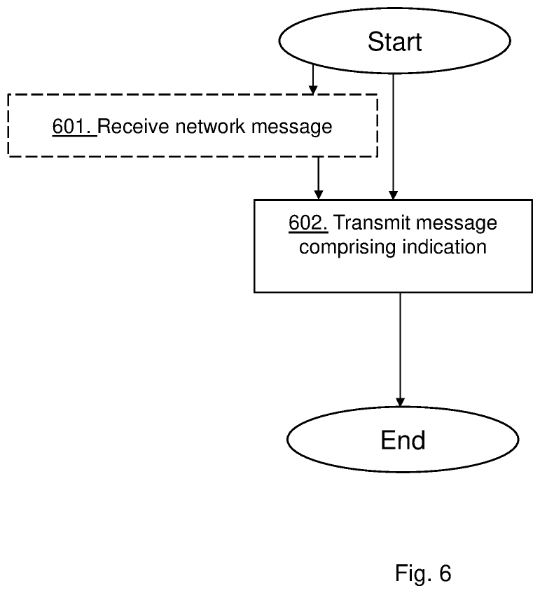

The method actions performed by the first IMS node 13 for handling SIP signalling in the communication network, for example, handling registering to an IMS network, according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The first IMS node 13 may receive the network message from the first network node 16, such as an NF node, wherein the network message indicates the group of subscriber servers comprising subscriber data of the UE 10. For example, the first IMS node 13 may receive a response to a discovery request comprising profiles of subscriber servers of the group of subscriber servers for the UE 10.

Action 602. The first IMS node 13 transmits the message related to the SIP signalling, such as an SIP INVITE, for the UE 10. The message comprises the indication indicating the group of subscriber servers, for example, HSS group ID and/or NF set, for the UE 10.

For example, indicating the group identity by using ‘Route: scscf-1.ericsson.com, P-User-Database: aaa://5gc.hssgid.hss-group-1.invalid’. The route header field is there to route to the correct S-CSCF. The indication of the group ID is in the P-User-Database. Thus, the indication may be comprised in a FQDN in the diameter URI. Thus, the FQDN may comprise an HSS group ID in the form of a token, a cookie or a format, which identifies that the diameter URI is not a valid URI but a HSS group ID, in order to reuse the P-User-Database header field to convey this information. This way, an existing SIP header is reused, but used for HSS addressing.

Alternatively, the indication may be comprised in ‘Route: scscf-1.ericsson.com, P-5gc-Group-Id: hss-group-1’. Thus, a new SIP header may be used comprising the indication, e.g., 5gc-Group-Id.

Alternatively, the indication may be comprised in ‘Route: <scscf-1.ericsson.com; 5gc-group-id=hss-group-1>’. Thus, the indication may be comprised in a route header where the S-CSCF name is included and a new URI parameter may be appended. Thus, reusing a SIP header which is used for SIP routing.

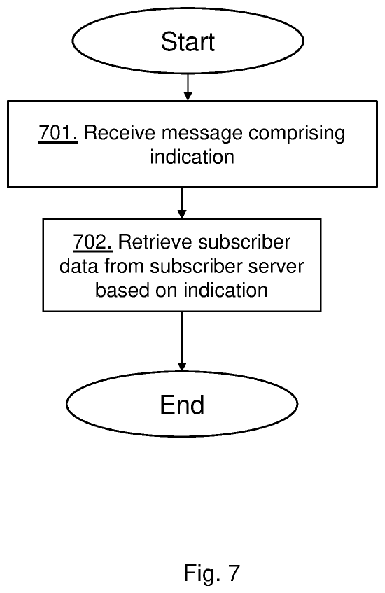

The method actions performed by the second IMS node 14 for handling SIP signalling in the communication network, for example, handling registering to an IMS network, according to embodiments herein will now be described with reference to a flowchart depicted in FIG. 7.

Action 701. The second IMS node 14 receives the message related to the SIP signalling, such as an SIP INVITE, for the UE 10, wherein the message comprises the indication indicating the group of subscriber servers for the UE 10.

For example, the indication may comprise a group identity by using ‘Route: scscf-1.ericsson.com, P-User-Database: aaa://5gc.hssgid.hss-group-1.invalid’. Thus, the indication may be comprised in an FQDN in the diameter URI. Thus, the FQDN may comprise an HSS group ID or NF set in the form of a token, a cookie or a format, which identifies that the diameter URI is not a valid URI but a group ID of HSSs, in order to reuse the P-User-Database header field to convey this information. This way, an existing SIP header is reused in a different protocol using a specific format.

Alternatively, the indication may be comprised in ‘Route: scscf-1.ericsson.com, P-5gc-Group-Id: hss-group-1’. Thus, a new SIP header may be used comprising the indication, e.g., 5gc-Group-Id.

Alternatively, the indication may be comprised in ‘Route: <scscf-1.ericsson.com; 5gc-group-id=hss-group-1>’. Thus, the indication may be comprised in a route header where the S-CSCF name is included, and a new URI parameter may be appended. Thus, reusing a SIP header which is used for SIP routing.

Action 702. The second IMS node 14 retrieves subscriber data of the UE 10 from the subscriber server based on the received indication. For example, the second IMS node 14 may detect the format of the Diameter URI and may fetch the group ID to use the HSS NF profiles cached. The second IMS node 14 may select a subscriber server for the UE 10 out of the group of subscriber servers indicated. The second IMS node may select the subscriber server based on a criterion such as proximity or similar. The second IMS node 14 may contact the subscriber server 15 directly without an NF node interaction.

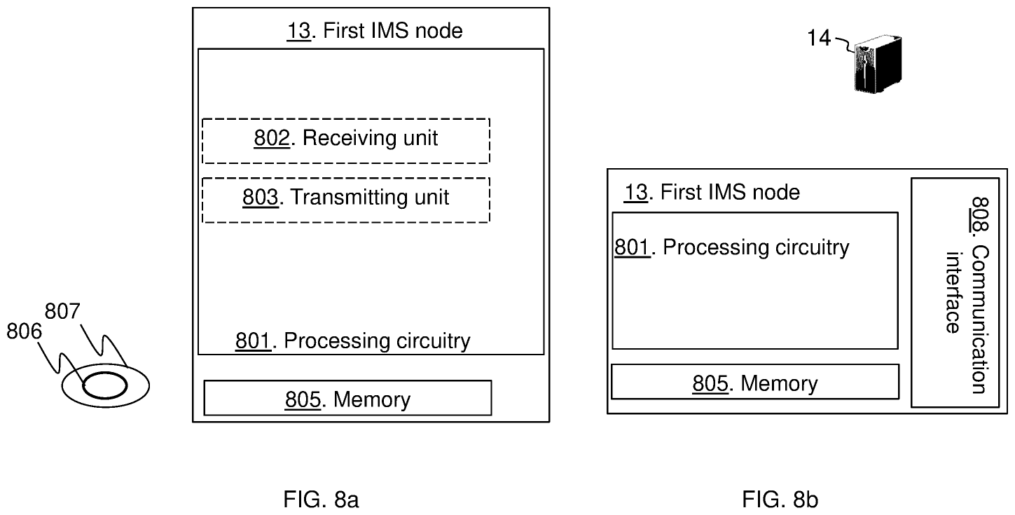

FIGS. 8a-8b are block diagrams depicting the first IMS node 13, in two embodiments, for handling SIP signalling in the communication network, for example, handling registering to an IMS network, according to embodiments herein.

The first IMS node 13 may comprise processing circuitry 801, e.g., one or more processors, configured to perform the methods herein.

The first IMS node 13 may comprise a receiving unit 802, such as a receiver or a transceiver. The first IMS node 13, the processing circuitry 801, and/or the receiving unit 802 may be configured to receive the network message, wherein the network message indicates the group of subscriber servers comprising subscriber data of the UE 10. For example, the first IMS node 13, the processing circuitry 801, and/or the receiving unit may be configured to receive a response to a discovery request comprising profiles of subscriber servers of the group of subscriber servers.

The first IMS node 13 may comprise a transmitting unit 803, such as a transmitter or a transceiver. The first IMS node 13, the processing circuitry 801, and/or the transmitting unit 803 is configured to transmit to the second IMS node 14, the message related to the SIP signalling for the UE 10, wherein the message comprises the indication indicating the group of subscriber servers for the UE 10.

For example, indicating the group identity by using ‘Route: scscf-1.ericsson.com, P-User-Database: aaa://5gc.hssgid.hss-group-1.invalid’. Thus, the indication may be comprised in an FQDN in the diameter URI. Thus, the FQDN may comprise an HSS group ID or NF set in the form of a token, a cookie or a format, which identifies that the diameter URI is not a valid URI but an HSS group ID, in order to reuse the P-User-Database header field to convey this information. This way, an existing SIP header is reused, but used for HSS addressing.

Alternatively, the indication may be comprised in ‘Route: scscf-1.ericsson.com, P-5gc-Group-Id: hss-group-1’. Thus, a new SIP header may be used comprising the indication, e.g., 5gc-Group-Id.

Alternatively, the indication may be comprised in ‘Route: <scscf-1.ericsson.com; 5gc-group-id=hss-group-1>’. Thus, the indication may be comprised in a route header where the S-CSCF name is included, and a new URI parameter may be appended. Thus, reusing a SIP header which is used for SIP routing, not for HSS addressing.

The first IMS node 13 further comprises a memory 805. The memory comprises one or more units to be used to store data on, such as indications, network messages, strengths or qualities, messages, execution conditions, user data, reconfiguration, configurations, applications to perform the methods disclosed herein when being executed, and similar. Thus, it is herein provided a first IMS node handling SIP signalling in the communication network, wherein the first IMS node comprises processor circuitry and a memory for storing instructions executable by said processor circuitry, and whereby the processing circuitry is operative to perform the method herein. The first IMS node 13 comprises a communication interface 808 comprising transmitter, receiver, and/or transceiver.

The methods according to the embodiments described herein for the first IMS node 13 are respectively implemented by means of, e.g., a computer program product 806 or a computer program product, comprising instructions, i.e., software code portions, which, when executed on at least one processor, cause the at least one processor to carry out the actions described herein, as performed by the first IMS node 13. The computer program product 806 may be stored on a computer-readable storage medium 807, e.g., a universal serial bus (USB) stick, a disc or similar. The computer-readable storage medium 807, having stored thereon the computer program product, may comprise the instructions which, when executed on at least one processor, cause the at least one processor to carry out the actions described herein, as performed by the first IMS node 13. In some embodiments, the computer-readable storage medium may be a non-transitory or transitory computer-readable storage medium.

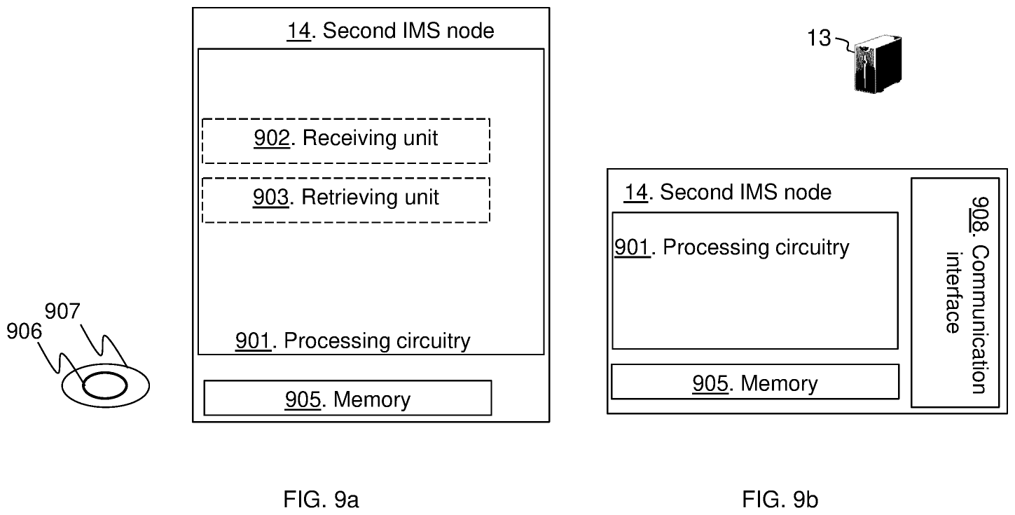

FIGS. 9a-9b are block diagrams depicting the second IMS node 14, in two embodiments, for handling SIP signalling in the communication network, for example, handling registering to an IMS network, according to embodiments herein.

The second IMS node 14 may comprise processing circuitry 901, e.g. one or more processors, configured to perform the methods herein.

The second IMS node 14 may comprise a receiving unit 902, such as a receiver or a transceiver. The second IMS node 14, the processing circuitry 901, and/or the receiving unit 902 is configured to receive the message related to the SIP signalling for the UE 10, wherein the message comprises the indication indicating the group of subscriber servers, such as an HSS group ID or an NF set, for the UE 10.

For example, indicating the group identity by using ‘Route: scscf-1.ericsson.com, P-User-Database: aaa://5gc.hssgid.hss-group-1.invalid’. Thus, the indication may be comprised in an FQDN in the diameter URI. Thus, the FQDN may comprise an HSS group ID in the form of a token, a cookie or a format, which identifies that the diameter URI is not a valid URI but an HSS group ID, in order to reuse the P-User-Database header field to convey this information. This way, an existing SIP header is reused, but used for HSS addressing.

Alternatively, the indication may be comprised in ‘Route: scscf-1.ericsson.com, P-5gc-Group-Id: hss-group-1’. Thus, a new SIP header may be used comprising the indication, e.g., 5gc-Group-Id.

Alternatively, the indication may be comprised in ‘Route: <scscf-1.ericsson.com; 5gc-group-id=hss-group-1>’. Thus, the indication may be comprised in a route header where the S-CSCF name is included, and a new URI parameter may be appended. Thus, reusing a SIP header which is used for SIP routing, not for HSS addressing.

The second IMS node 14 may comprise a retrieving unit 903. The second IMS node 14, the processing circuitry 901, and/or the retrieving unit 903 is configured to retrieve subscriber data of the UE 10, from the subscriber server, based on the received indication. Thus, the second IMS node 14, the processing circuitry 901, and/or the retrieving unit 903 may be configured to select an HSS based on the received indication. The second IMS node 14, the processing circuitry 901, and/or the retrieving unit 903 may be configured to retrieve the subscriber data of the UE 10 by detecting a format of a Diameter URI and fetching a group ID of home subscriber servers. For example, the second IMS node 14, the processing circuitry 901, and/or the retrieving unit 903 may be configured to detect the format of the Diameter URI and may fetch the group ID to use the HSS NF profiles cached. The second IMS node 14, the processing circuitry 901, and/or the retrieving unit 903 may be configured to select and contact the subscriber server 15 directly without an NF node interaction.

The second IMS node 14 further comprises a memory 905. The memory comprises one or more units to be used to store data on, such as indications, network messages, strengths or qualities, messages, execution conditions, user data, reconfiguration, configurations, applications to perform the methods disclosed herein when being executed, and similar. Thus, it is herein provided a second IMS node for handling SIP signalling in the communication network, wherein the second IMS node comprises processor circuitry and a memory for storing instructions executable by said processor circuitry, and whereby the processing circuitry is operative to perform the method herein. The second IMS node 14 comprises a communication interface 908 comprising transmitter, receiver, and/or transceiver.

The methods according to the embodiments described herein for the second IMS node 14 are respectively implemented by means of, e.g., a computer program product 906 or a computer program product, comprising instructions, i.e., software code portions, which, when executed on at least one processor, cause the at least one processor to carry out the actions described herein, as performed by the second IMS node 14. The computer program product 906 may be stored on a computer-readable storage medium 907, e.g., a universal serial bus (USB) stick, a disc or similar. The computer-readable storage medium 907, having stored thereon the computer program product, may comprise the instructions which, when executed on at least one processor, cause the at least one processor to carry out the actions described herein, as performed by the second IMS node 14. In some embodiments, the computer-readable storage medium may be a non-transitory or transitory computer-readable storage medium.

In some embodiments a more general term “network node” is used and it can correspond to any type of radio network node or any Core network node, which communicates with a wireless/wireline device and/or with another network node. Examples of network nodes are instantiations of: NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), gateways, transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless/wireline device or user equipment (UE) is used and it refers to any type of wireless/wireline device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a first Internet Protocol Multimedia Subsystem, IMS, node for handling session initiation protocol, SIP, signalling in a communication network, the method comprising:
transmitting to a second IMS node, a message related to SIP signalling for a user equipment, UE, wherein the message comprises an indication indicating a group of subscriber servers.

2. The method according to claim 1, wherein the indication is comprised in a fully qualified domain name, FQDN, in a diameter uniform resource identifier, URI.

3. The method according to claim 1, wherein the indication comprises a token, a cookie or a format, which identifies that a diameter uniform resource identifier, URI, is not a valid URI.

4. The method according to claim 1, wherein the indication is comprised in a P-User-Database header field.

5. The method according to claim 1, wherein the indication is comprised in a new SIP header.

6. The method according to claim 1, wherein the indication is comprised in a header where the second IMS node is indicated and a uniform resource identifier, URI, parameter is appended indicating the group of subscriber servers.

7. The method according to claim 1, wherein the message is related to a registering of the UE to an IMS network.

8. The method according to claim 1, further comprising
receiving a network message from a first network node, wherein the network message indicates the group of subscriber servers comprising subscriber data of the UE.

9. The method according to claim 8, wherein the network message comprises a response, to a discovery request, comprising one or more profiles of subscriber servers of the group of subscriber servers.

10. A method performed by a second Internet Protocol Multimedia Subsystem, IMS, node for handling session initiation protocol, SIP, signalling in a communication network, the method comprising:
receiving from a first IMS node, a message related to SIP signalling for a user equipment, UE, wherein the message comprises an indication indicating a group of subscriber servers for the UE; and
retrieving subscriber data of the UE from a subscriber server based on the received indication.

11. The method according to claim 10, wherein the indication is comprised in a fully qualified domain name, FQDN, in a diameter uniform resource identifier, URI.

12. The method according to claim 10, wherein the indication comprises a token, a cookie or a format, which identifies that a diameter uniform resource identifier, URI, is not a valid URI.

13. The method according to claim 10, wherein the indication is comprised in a P-User-Database header field.

14. The method according to claim 10, wherein the indication is comprised in a new SIP header.

15. The method according to claim 10, wherein the indication is comprised in a header where the second IMS node is indicated and a uniform resource identifier, URI, parameter is appended indicating the identity of the group of subscriber servers.

16. The method according to claim 10, wherein the message is related to a registering of the UE to an IMS network.

17. The method according to claim 10, wherein retrieving the subscriber data of the UE comprises detecting a format of a Diameter uniform resource identifier, URI, and fetching a group ID of home subscriber servers.

18. A computer program product comprising instructions, which, when executed on at least one processor, cause the at least one processor to carry the method according to claim 1, as performed by the first and second IMS node, respectively.

19. A computer-readable storage medium, having stored thereon a computer program product comprising instructions which, when executed on at least one processor, cause the at least one processor to carry out the method according to claim 1, as performed by the first and second IMS node, respectively.

20. A first Internet Protocol Multimedia Subsystem, IMS, node for handling session initiation protocol, SIP, signalling in a communication network, wherein the first IMS node is configured to
transmit to a second IMS node, a message related to SIP signalling for a user equipment, UE, wherein the message comprises an indication indicating a group of subscriber servers for the UE.

21-36. (canceled)
